(19) United States
(12) Patent Application Publication
(10) Pub. No.: US 2008/0246691 A1
(43) Pub. Date: Oct. 9, 2008

(54) ANTENNA APPARATUS

(75) Inventor: Norio Yoshie, Aichi-ken (JP)

Correspondence Address: MILLS & ONELLO LLP, ELEVEN BEACON STREET, SUITE 605, BOSTON, MA, 02108, US

(73) Assignee: KOJIMA PRESS INDUSTRY CO., LTD., Aichi-ken (JP)

(21) Appl. No.: 12/057,953

(22) Filed: Mar. 28, 2008

(30) Foreign Application Priority Data
Apr. 4, 2007 (JP) 2007-98274

(51) Int. Cl. H01Q 1/50

(52) U.S. Cl. 343/906

(57) ABSTRACT

A joint includes a cable receiving groove to which a coaxial cable is fixed. The joint further includes, at both ends of the cable receiving groove, an element setup portion to which the antenna element can be attached and fixed and a ground setup portion to which the ground can be attached and fixed. The element setup portion includes engagement protrusions that can engage with engagement holes of the antenna element. The ground setup portion includes engagement protrusions that can engage with engagement holes of the ground. The engagement of the protrusions and the holes can define the positions of the antenna element and the ground relative to the joint and also defines a mutual position between the antenna element and the ground.

### PRIORITY INFORMATION

This application claims priority to Japanese Patent Application No. 2007-98274, filed on Apr. 4, 2007, which is incorporated herein by reference in its entirety.

### BACKGROUND OF THE INVENTION

1. Field of the Invention

The present invention relates to an antenna apparatus.

2. Description of the Related Art

Performance of an antenna apparatus is dependent on a positional relationship between an antenna element performing radio wave transmission/reception and a ground. FIG. 1 illustrates a conventional antenna apparatus 100 including a planar antenna element 102 and a ground 104 disposed on substantially the same plane. The antenna element 102 and the ground 104 are sandwiched between two laminate sheets 106 and integrated together. A conventional antenna discussed in Japanese Patent Application Laid-Open No. 2005-318203 includes an antenna element sandwiched between laminate sheets.

According to the above-described conventional antenna apparatus, accurately determining a positional relationship between an antenna element and a ground is difficult.

### SUMMARY OF THE INVENTION

The present invention provides an antenna structure capable of accurately defining a relative position between an antenna element and a ground.

An antenna apparatus according to the present invention includes a joint member to which an antenna element and a ground are attached and fixed. The joint member defines a relative positional relationship between the antenna element and the ground. The joint member includes an element setup portion engaged with an engagement structure provided on the antenna element for positioning and fixing the antenna element. Furthermore, the joint member includes a ground setup portion engaged with an engagement structure provided on the ground for positioning and fixing the ground.

The joint member may include a cable fixing portion which is positioned between the element setup portion and the ground setup portion and can fix the coaxial cable. The cable fixing portion may include first and second walls defining a groove that can receive the coaxial cable. The first wall separates the element setup portion from the coaxial cable when the coaxial cable is positioned in the groove. The second wall separates the ground setup portion from the coaxial cable when the coaxial cable is positioned in the groove. The first wall may include a first notch capable of positioning an internal conductor of the coaxial cable connected to the antenna element. The second wall may include a second notch capable of positioning an external conductor of the coaxial cable connected to the ground.

The positioning of the antenna element relative to the joint member may be realized by an engagement of an engagement protrusion provided on the element setup portion and an engagement hole provided on the antenna element.

The positioning of the ground relative to the joint member may be realized by an engagement of an engagement protrusion provided on the ground setup portion and an engagement hole provided on the ground.

### BRIEF DESCRIPTION OF THE DRAWINGS

The accompanying drawings, which are incorporated in and constitute a part of the specification, illustrate a preferred embodiment of the invention and, together with the description, serve to explain the principles of the invention, in which:

FIG. 1 illustrates a conventional antenna apparatus;

FIG. 2 illustrates a schematic arrangement of an antenna apparatus according to an embodiment;

FIG. 3 illustrates a detailed configuration of a joint serving as a joint member of an antenna apparatus;

FIG. 4 illustrates a coaxial cable fixed to the joint; and

FIG. 5 illustrates a hot-melt coating covering the joint.

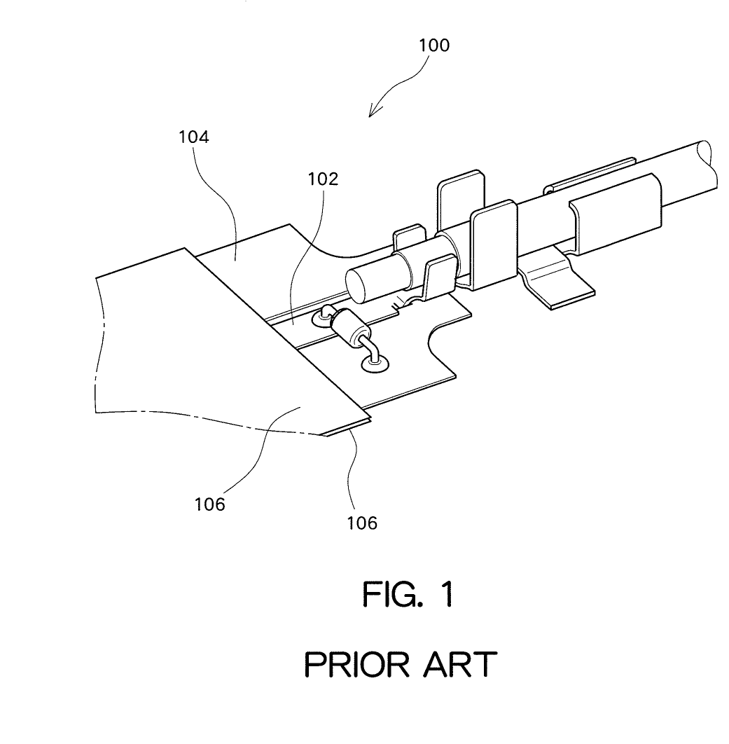

### DESCRIPTION OF PREFERRED EMBODIMENT

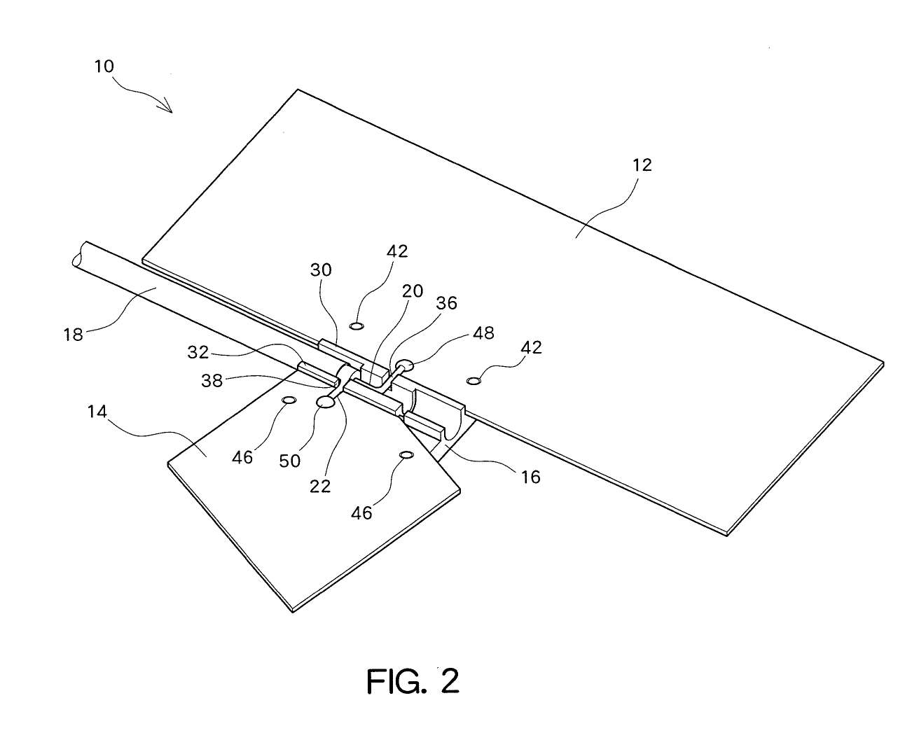

An embodiment of the present invention is described below with reference to the attached drawings. FIG. 2 is a perspective view illustrating a schematic arrangement of an antenna apparatus 10 according to the present invention. The antenna apparatus 10 includes a planar antenna element 12 and a planar ground 14. The antenna element 12 and the ground 14 are attached and fixed to a joint 16 which is made of an insulation member. A coaxial cable 18 is fixed to the joint 16 at one end. The coaxial cable 18 has an internal conductor 20 connected or soldered to the antenna element 12 and an external conductor 22 connected or soldered to the ground 14. The other end of the coaxial cable 18 is connected to a transmission/reception circuit (not illustrated) mounted on a circuit substrate.

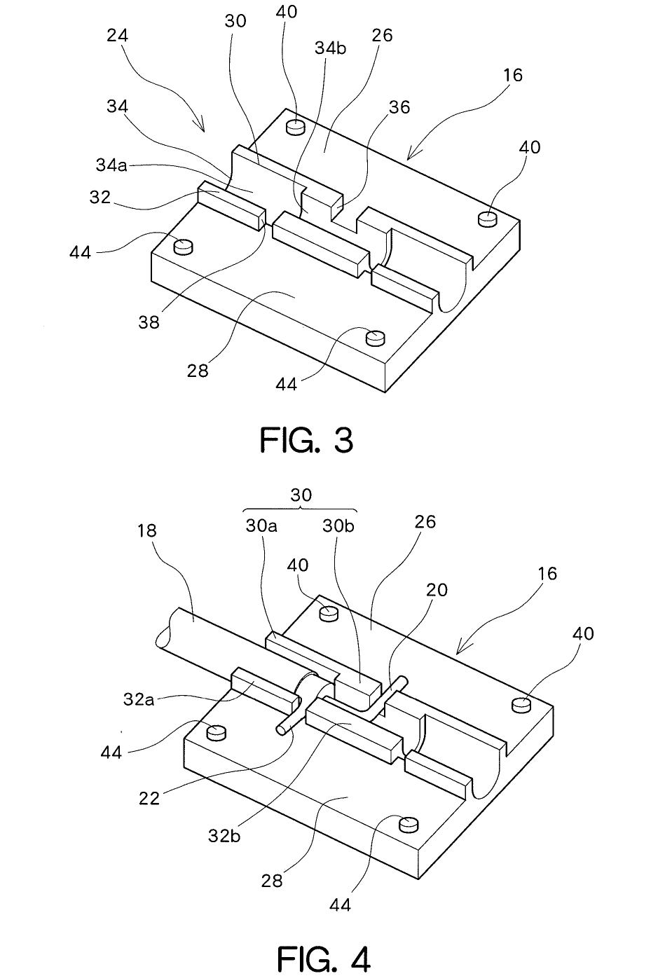

FIG. 3 illustrates the joint 16. FIG. 4 illustrates a coaxial cable 18 fixed to the joint 16 in a state where the antenna element 12 and the ground 14 are omitted. As illustrated in FIG. 3, the joint 16 is a plate member configured into a rectangular shape. The joint 16 has a cable fixing portion 24 at its center where the coaxial cable 18 can be fixed, and also has an element setup portion 26 and a ground setup portion 28 at both ends thereof.

The cable fixing portion 24 includes a cable receiving groove 34 which is defined by first and second walls 30 and 32 and capable of receiving the coaxial cable 18. The first wall 30 has a height greater than that of an “element fitting surface” of the element setup portion 26 on which the antenna element 12 can be attached. The first wall 30 can separate the antenna element 12 from the coaxial cable 18 received in the cable receiving groove 34. The second wall 32 has a height greater than that of a “ground fitting surface” of the ground setup portion 28 on which the ground 14 can be attached. The second wall 32 can separate the ground 14 from the coaxial cable 18 received in the cable receiving groove 34. The element fitting surface of the element setup portion 26 and the ground fitting surface of the ground setup portion 28 are positioned on the same plane. The cable receiving groove 34 extends along this plane.

The cable receiving groove 34 has a large-diameter portion 34a which is positioned near an edge of the joint 16 and has a larger inner diameter, and a small-diameter portion 34b which is positioned at the center of the joint 16 and has a smaller inner diameter. The first wall 30 has a thin portion 30a at a position corresponding to the large-diameter portion 34a and a thick portion 30b at a position corresponding to the small-diameter portion 34b (refer to FIG. 4). Similarly, the second wall 32 has a thin portion 32a and a thick portion 32b.

The large-diameter portion 34a has an inner diameter corresponding to an outer diameter of the coaxial cable 18, so that the large-diameter portion 34a can accommodate the coaxial cable 18. The small-diameter portion 34b has an inner diameter corresponding to a diameter of the internal conductor 20 of the coaxial cable 18, so that the small-diameter portion 34b can accommodate the internal conductor 20 of the coaxial cable 18.

The thick portion 30b of the first wall 30 has a first notch 36 positioning the internal conductor 20 of the coaxial cable 18 which extends toward the element setup portion 26. A second notch 38 positioning the external conductor 22 of the coaxial cable 18 is formed between the thin portion 32a and the thick portion 32b of the second wall 32. The external conductor 22, held by the second notch 38, extends toward the ground setup portion 28. The first notch 36 is positioned at the center of the cable receiving groove 34 in the longitudinal direction. The right and left halves of the cable receiving groove 34 are symmetrical to each other. Namely, the right half of the cable receiving groove 34 includes a large-diameter portion, a small-diameter portion, and a second notch, as illustrated in FIG. 3.

The element setup portion 26 includes two engagement protrusions 40 provided on its element fitting surface. The engagement protrusions 40 engage with engagement holes 42 of the antenna element 12 and define a relative positional relationship between the joint 16 and the antenna element 12. Furthermore, the engagement of the protrusions 40 and the engagement holes 42 defines a positional relationship between the first notch 36 of the joint 16 and the antenna element 12, and accurately determines a soldering position (indicated by reference numeral 48 in FIG. 2) on the antenna element 12.

The soldering position, i.e., the position of a power supply point, has an effect on performance of the antenna. Improving the positioning accuracy may stabilize the antenna performance.

The ground setup portion 28 includes two engagement protrusions 44 provided on its element fitting surface. These engagement protrusions 44 can engage with engagement holes 46 of the ground 14 and define a relative positional relationship between the joint 16 and the ground 14. The above-described engagement structure of the element setup portion 26 and the engagement structure of the ground setup portion 28 determine a relative positional relationship between the antenna element 12 and the ground 14. The number of the engagement protrusions (40, 44) and corresponding engagement holes (42 or 46) is not limited to two.

If the element setup portion 26 has only one engagement protrusion 40, the first wall 30 can prevent the antenna element 12 from rotating around the protrusion 40. Similarly, if the ground setup portion 28 has only one engagement protrusion 44, the second wall 32 can prevent the ground 14 from rotating around the protrusion 44. As another embodiment, three or more engagement protrusions may be provided on respective fitting surfaces.

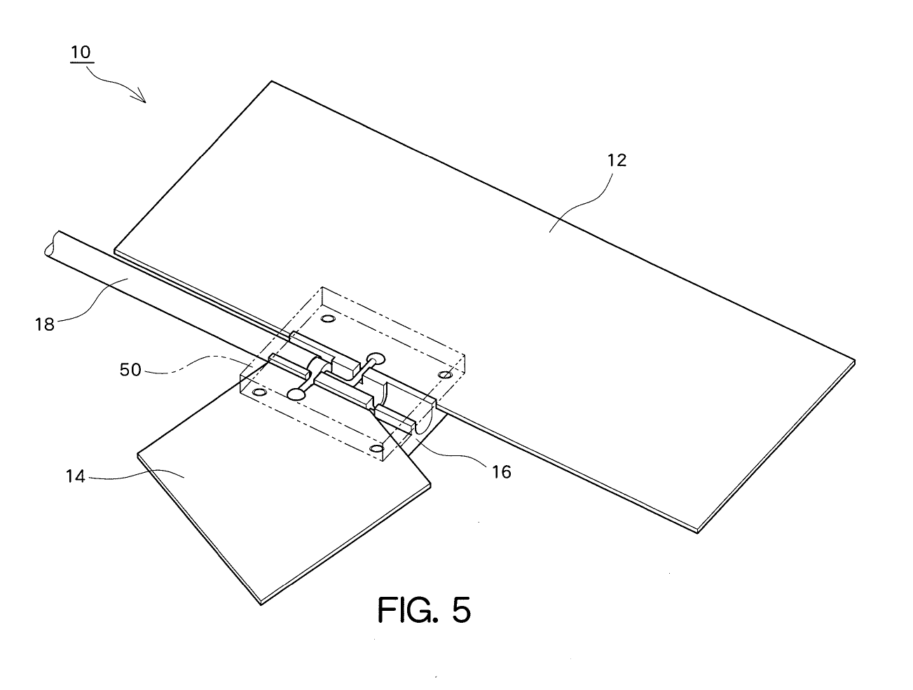

A hot-melt coating 50, applied after completing the soldering of the internal and external conductors 20 and 22 of the coaxial cable 18, covers an upper surface of the joint 16 and seals the exposed portions of the internal and external conductors 20 and 22, as indicated by an alternate long and short dash line illustrated in FIG. 5.

The connection of the internal conductor 20 to the antenna element 12 and the connection of the external conductor 22 to the ground 14 are not limited to soldering. For example, comparable connections can be realized by calking, press-fitting, or welding. Furthermore, the ground is not limited to a flat plate and can be a bolt, a nut, or a washer. The antenna element can be configured into a rod shape or a helical shape.

What is claimed is:

1. An antenna apparatus comprising:
an antenna element;
a ground;
a coaxial cable including an internal conductor connected to the antenna element and an external conductor connected to the ground; and
a joint member to which the antenna element and the ground are attached and fixed,
wherein the joint member comprises:
an element setup portion engaged with an engagement structure provided on the antenna element for positioning and fixing the antenna element; and
a ground setup portion engaged with an engagement structure provided on the ground for positioning and fixing the ground.

2. The antenna apparatus according to claim 1, wherein
the joint member includes a cable fixing portion which is positioned between the element setup portion and the ground setup portion and fixes the coaxial cable,
the cable fixing portion includes first and second walls defining a groove that receives the coaxial cable,
the first wall separates the element setup portion from the coaxial cable when the coaxial cable is positioned in the groove,
the second wall separates the ground setup portion from the coaxial cable when the coaxial cable is positioned in the groove, and
the first wall includes a first notch capable of positioning the internal conductor, and the second wall includes a second notch capable of positioning the external conductor.

3. The antenna apparatus according to claim 2, wherein the engagement structure of the antenna element is at least one engagement hole and the element setup portion has at least one engagement protrusion that engages with the engagement hole, so that an engagement of the engagement hole and the engagement protrusion realizes a positioning of the antenna element.

4. The antenna apparatus according to claim 2, wherein the engagement structure of the ground is at least one engagement hole and the ground setup portion has at least one engagement protrusion that engages with the engagement hole, so that an engagement of the engagement hole and the engagement protrusion realizes a positioning of the ground.

5. A joint member to which an antenna element and a ground of an antenna apparatus are attached and fixed, the joint member comprising:
an element setup portion engaged with an engagement structure provided on the antenna element for positioning and fixing the antenna element; and
a ground setup portion engaged with an engagement structure provided on the ground for positioning and fixing the ground.

6. The joint member for an antenna apparatus according to claim 5, further comprising:
a cable fixing portion which is positioned between the element setup portion and the ground setup portion and fixes a coaxial cable having an internal conductor connected to the antenna element and an external conductor connected to the ground,
wherein the cable fixing portion includes first and second walls defining a groove that can receive the coaxial cable,
the first wall separates the element setup portion from the coaxial cable when the coaxial cable is positioned in the groove,
the second wall separates the ground setup portion from the coaxial cable when the coaxial cable is positioned in the groove, and
the first wall includes a first notch capable of positioning the internal conductor, and the second wall includes a second notch capable of positioning the external conductor.

7. An antenna apparatus comprising:
an antenna element;
a ground;
a coaxial cable including an internal conductor connected to the antenna element and an external conductor connected to the ground;
a joint member to which the antenna element and the ground are attached and fixed,
wherein the joint member comprises:
an element setup portion for positioning and fixing the antenna element; and
a ground setup portion for positioning and fixing the ground; and
a cable fixing portion which is positioned between the element setup portion and the ground setup portion and fixes the coaxial cable,
wherein the cable fixing portion includes first and second walls defining a groove that receives the coaxial cable,
the first wall separates the element setup portion from the coaxial cable when the coaxial cable is positioned in the groove,
the second wall separates the ground setup portion from the coaxial cable when the coaxial cable is positioned in the groove, and
the first wall includes a first notch capable of positioning the internal conductor, and the second wall includes a second notch capable of positioning the external conductor.
